(19) United States
(12) Patent Application Publication
(10) Pub. No.: US 2005/0184516 A1
(43) Pub. Date: Aug. 25, 2005

(54) Pipette stabilizer

(76) Inventors: Daniel Seguin, Amherst, NH (US); Gregory Mathus, Concord, MA (US)

Correspondence Address: Attn: Maurice E. Gauthier;Gauthier & Connors, LLP, 225 Franklin Street, Suite 3300, Boston, MA, 02110, US

(21) Appl. No.: 10/784,385

(22) Filed: Feb. 23, 2004

(51) Int. Cl. F16L 37/00

(52) U.S. Cl. 285/307

(57) ABSTRACT

A mounting fixture for connecting pipettes of various sizes to the air channel of a pipettor comprises a tubular nose having a proximate end secured to the pipettor and an open distal end. A resilient retainer lines the interior of the tubular nose. The retainer has an axial passageway communicating at its entry and exit openings respectively with the open distal end of the tubular nose and with the air channel of the pipettor. The passageway is tapered from a maximum diameter at its entry opening to a minimum diameter at its exit opening. The entry opening is sized to axially receive the largest of the pipettes and the sleeve is internally configured to resiliently grip differently sized pipettes inserted therein at different locations along the length thereof. A stabilizing member is provided at the open distal end of the tubular nose. The stabilizing member is configured to radially confine and support pipettes received in the axial passageway of the resilient retainer.

### BACKGROUND OF THE INVENTION

1. Field of the Invention

This invention relates generally to pipettors having nozzle assemblies configured to accept pipettes of varying diameters, and is concerned in particular with an improvement in the stabilization of the smaller diameter pipettes.

2. Description of the Prior Art

With reference initially to FIG. 1, a known pipettor 10 has a generally tubular nozzle 12 with a proximate end 12a connected to the pipettor housing, and with a distal end 12b defining an opening 14 large enough to accept the largest of the pipettes available for use with the pipettor.

A resilient retainer 16 lines the interior of the nose 12. The retainer has an internally ribbed passageway 18 converging from an enlarged diameter entry opening 20 at the open distal end of the nozzle to a comparatively smaller diameter exit opening 22 leading to the air channel 24 of the pipettor.

The larger diameter pipettes are axially inserted through the adjacent aligned openings 14, 20 and are gripped and held air tight by the ribbed wall of passageway 18 at a location intermediate its ends. The reasonably close fit between the larger diameter pipettes and the entry opening 20 provides an acceptable measure of stabilization against tip wobble. However, as shown in FIG. 1, because of the substantial radial clearance between the smaller diameter pipettes 26 and the edges of the openings 14, 20, the pipettes lack adequate stabilization and are thus prone to loosely pivot or wobble as indicated diagrammatically by the arrow 28. This wobble makes it difficult to insert the pipette into small necked containers or tubes.

The objective of the present invention is to provide added stabilization for the smaller diameter pipettes, thereby avoiding or at least substantially minimizing pipette wobble.

### SUMMARY OF THE INVENTION

In accordance with the present invention, a stabilizing member is provided at the entry opening of the retainer passageway. The stabilizing member is configured and dimensioned to reduce or eliminate the clearances permitting pivotal movement of the pipettes within the confines of the retainer entry opening.

These and other features and advantages of the present invention will now be described in greater detail with reference to the accompanying drawings, wherein:

### BRIEF DESCRIPTION OF THE DRAWINGS

FIG. 1 is a partially sectioned side view of a relatively small diameter pipette supported in the nozzle assembly of a known pipettor;

FIG. 2 is an enlarged partially sectioned side view of the pipettor nozzle assembly modified by the addition of one embodiment of a stabilizing member in accordance with the present invention;

FIG. 3 is a perspective view of the stabilizing member shown in FIG. 2;

FIG. 4 is a vertical sectional view of the stabilizing member shown in FIGS. 2 and 3;

FIG. 5 is a vertical sectional view through the pipettor nozzle assembly and showing an alternative embodiment of a stabilizing member in accordance with the present invention;

FIGS. 6a-6d are perspective views showing different configurations of stabilizing members of the type shown in FIG. 5;

FIG. 7 is a bottom perspective view showing in still another embodiment of stabilizing member in accordance with the present invention;

FIG. 8 is a vertical sectional view of the stabilizing member and nozzle assembly shown in FIG. 7;

FIG. 9 is a perspective view of one of the half sections of the stabilizing member shown in FIGS. 7 and 8; and

FIG. 10 is a bottom perspective view showing a modified entry opening for the stabilizing member depicted in FIGS. 7 and 8.

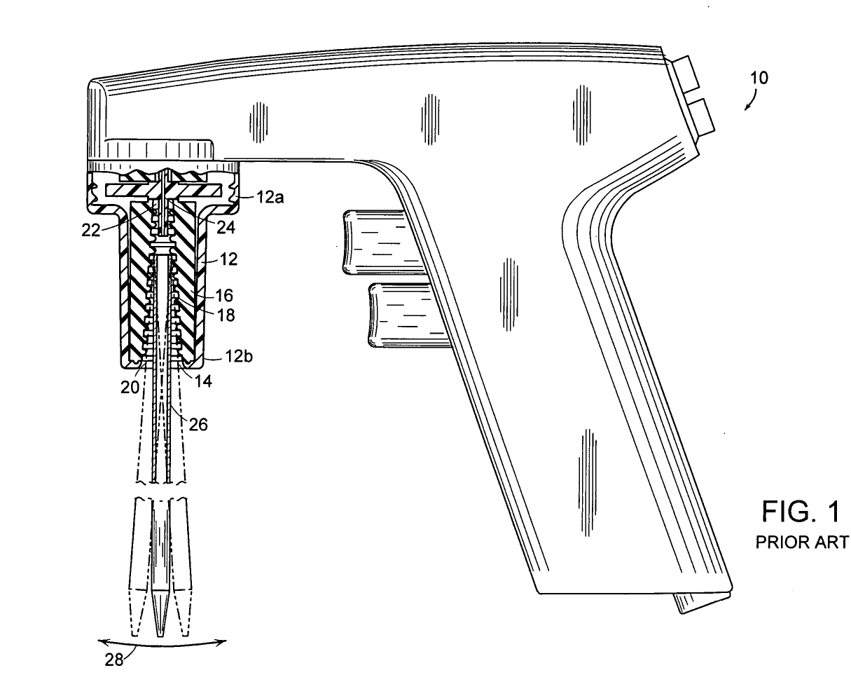

### DETAILED DESCRIPTION OF PREFERRED EMBODIMENTS

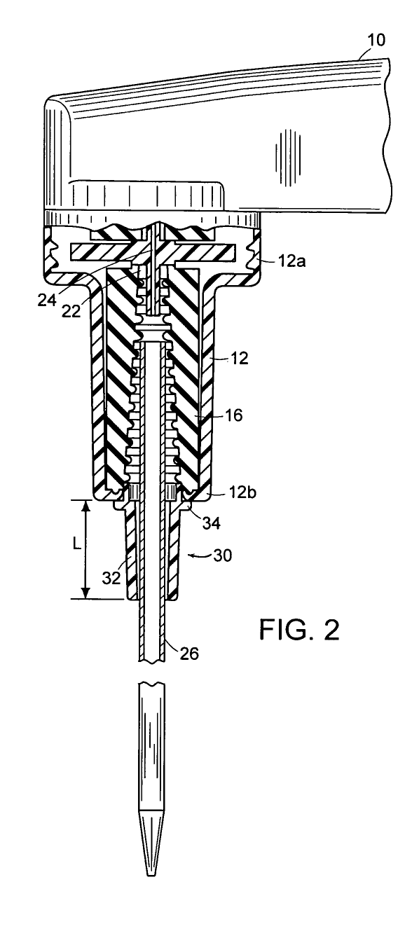

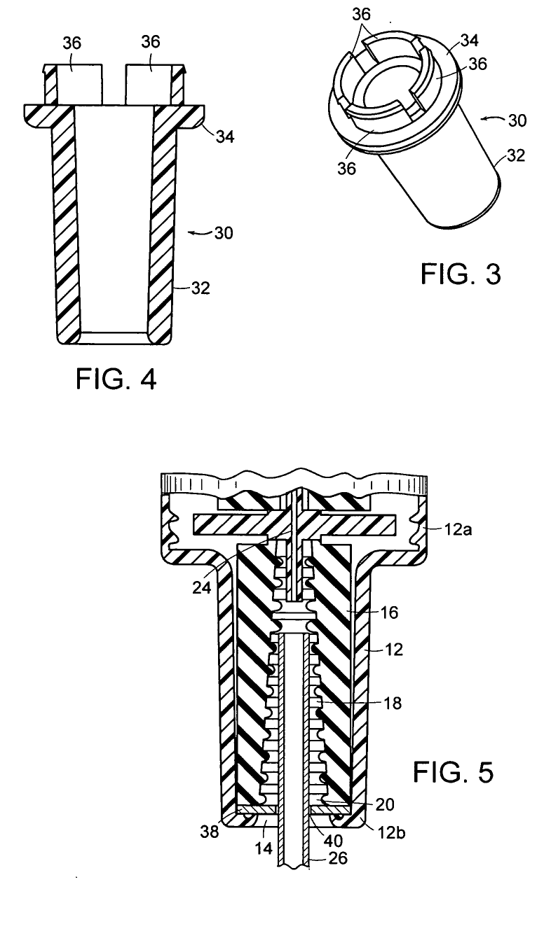

With reference to FIGS. 2-4, a first embodiment of a stabilizing member is generally indicated at 30. The stabilizing member includes a tubular sleeve 32 projecting axially from one side of an enlarged diameter flange 34. Partially circular circumferentially spaced ears 36 project axially in the opposite direction from the opposite side of flange 34. The stabilizing member 30 is advantageously molded as an integral unit from a relatively rigid plastics, e.g., acetal, polycarbonate, ABS, etc., with the ears 36 being appropriately configured and dimensioned for removable snap-fit insertion into the opening 14 in the distal end 12b of nozzle 12. The inner diameter of the sleeve 32 is smaller than that of the entry opening 20 of retainer 16, and is sized as shown in FIG. 2 to closely confine the smaller diameter pipettes 26. The length “L” of projection of the stabilizing member 30 from the distal end of the nose 12 is preferably at least about 0.5 times the minimum diameter of the passageway 18 extending through the retainer 16.

The stabilizing member 30 may be conveniently separated from the pipettor nozzle when using large diameter pipette tips (those having diameters larger than the inner diameter of sleeve 32), and may be snapped into place prior to usage of smaller diameter pipettes. When in place, the stabilizing member prevents or at least substantially minimizes any tendency of the pipettes to wobble.

With reference to FIG. 5, an alternative embodiment of a stabilizing member comprises a relatively thin resilient annular disc 38 located at the entry opening 20 of the retainer 16 and captured within the distal end 12b of nozzle 12. The disc 38 has a central opening 40 sized to closely confine smaller diameter pipettes 26.

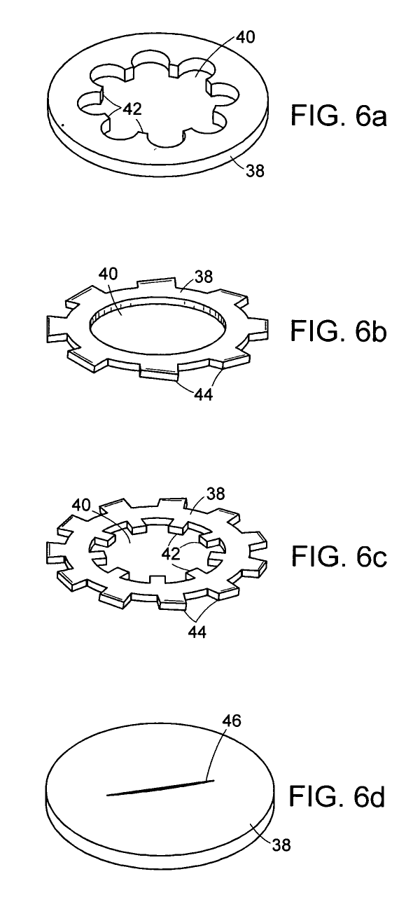

The annular disc 38 may be variable configured. Thus, for example, as shown in FIG. 6a, the central opening 40 may be bordered by radially inwardly projecting teeth 42. Alternatively, as shown in FIG. 6b, the disc may have radially outwardly projecting teeth 44, or as shown in FIG. 6c, both inwardly and outwardly projecting teeth 42, 44 may be provided. As shown in FIG. 6d, the disc 38 may alternatively be provided with a slot 46 that will resiliently expand to accommodate pipette tips of varying diameters.

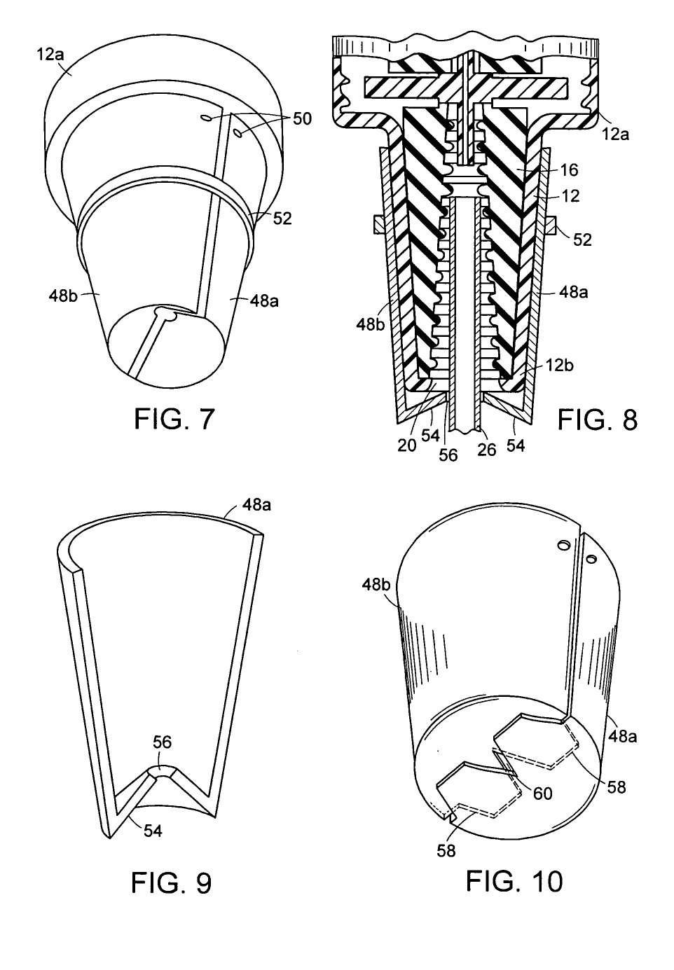

Still another embodiment of the invention is disclosed in FIGS. 7-9. Here, the pipettor nozzle 12 is encased by an outer stabilizer comprising mating half sections 48a, 48b pivotally connected to the nozzle as at 50 and resiliently closed by an elastic band 52. The bottoms of the two half sections are tapered inwardly as at 54 to a central opening 56, the diameter of which is again smaller than that of the entry opening 20 of the retainer 16. This inward taper facilitates insertion of the pipettes, and the resiliently pivotal coaction of the two halves 48a, 48b accommodates a range of pipette diameters.

Alternatively, as shown in FIG. 10, the bottoms of the two halves 48a, 48b may overlap as at 58 to define a narrow but expandable opening 60.

In light of the foregoing, it will now be appreciated by those skilled in the art that by employing stabilizing members in accordance with the various embodiments of the present invention, stability of the smaller diameter pipettes is beneficially enhanced. The stabilizer members may be readily attachable and detachable as shown in FIGS. 2-4, and as such useful for stabilizing only the smaller diameter range of pipettes. Resilient internal stabilizer members of the type shown in FIGS. 5 and 6a-6d can accommodate a wider range of pipette diameters, as can the external split design shown in FIGS. 7-10.

1. A mounting fixture for connecting pipettes of various sizes to the air channel of a pipettor, said fixture comprising:
a tubular nose having a proximate end secured to said pipettor and an open distal end;
a resilient retainer lining the interior of said nose, said retainer having an axial passageway communicating at its entry and exit openings respectively with the open distal end of said nose and with the air channel of the pipettor, said passageway being tapered from a maximum diameter at said entry opening to a minimum diameter at said exit opening, said entry opening being sized to axially receive the largest of said pipettes and said sleeve being internally configured to resiliently grip differently sized pipettes inserted therein at different locations along the length thereof; and
a stabilizing member at the open distal end of said nose, said stabilizing member being configured to radially confine and support pipettes received in the axial passageway of said resilient retainer.

2. The mounting fixture of claim 1 wherein said stabilizing member comprises a tubular sleeve projecting axially from the distal end of said nose.

3. The mounting fixture of claims 1 or 2 wherein said stabilizing member is rigid, is detachably secured to the distal end of said nose, and has an inner diameter smaller than that of the entry opening of said resilient retainer.

4. The mounting fixture of claim 3 wherein said stabilizing member is snap fitted into the open distal end of said tubular nose.

5. The mounting fixture of claim 1 wherein said stabilizing member projects axially from the distal end of said nose by a distance at least about 0.5 times the minimum diameter of the axial passageway in said resilient retainer.

6. The mounting fixture of claim 1 wherein said stabilizing member comprises a resilient annular disc enclosed within said tubular nose at the open distal end thereof, said disc having a central opening therein configured and dimensioned to frictionally engage pipette tips inserted in the passageway in said retainer.

7. The mounting fixture of claim 6 wherein the diameter of said central opening is smaller than the entry opening of the axial passageway in said retainer.

8. The mounting fixture of claim 7 wherein said annular disc has radially inwardly projecting teeth.

9. The mounting fixture of claim 7 wherein said annular disc has radially outwardly projecting teeth.

10. The mounting fixture of claim 7 wherein said annular disc has both radially inwardly projecting teeth and radially outwardly projecting teeth.

11. The mounting fixture of claim 1 wherein said stabilizing member is subdivided into mating sections enclosing said nose and defining an opening aligned with the open distal end of said nose and the passageway in said retainer, said mating sections being resiliently deflectable to receive and frictionally grip pipette tips of varying diameters inserted through said opening.
